(19) United States
(12) Patent Application Publication
(10) Pub. No.: US 2008/0311985 A1
(43) Pub. Date: Dec. 18, 2008

(54) Systems and methods for monitoring video gaming and determining opportunities to display content related applications

(75) Inventors: Bradford L. Rajani, Greendale, WI (US); Michael Polyak, Thornhill (CA)

Correspondence Address: RYAN KROMHOLZ & MANION, S.C., POST OFFICE BOX 26618, MILWAUKEE, WI, 53226, US

(73) Assignee: Wansanity LLC

(21) Appl. No.: 12/156,283

(22) Filed: May 30, 2008

Related U.S. Application Data
(60) Provisional application No. 60/932,786, filed on Jun. 1, 2007.

(51) Int. Cl. A63F 13/00

(52) U.S. Cl. 463/31; 463/42

(57) ABSTRACT

A system and method to detect moments of decreased user interactivity in any video game being played over a network, to allow third party advertisements inside visual display of the game during this time. The method generally includes a listening stage, a measuring stage, and a rendering stage. The system determines moments of user interactivity by analyzing the rate of network calls and graphical calls from the game to the computing device.

### RELATED APPLICATIONS

This application claims the benefit of co-pending U.S. Provisional Patent Application Ser. No. 60/932,786, filed 1 Jun. 2007.

### BACKGROUND OF THE INVENTION

Video games are a bourgeoning form of media entertainment that currently eclipse, when measured by gross sales, many other forms of media such as music and movies. Despite their popularity, video games have not been an influential medium for advertising to consumers, and certainly not so when compared to their media counterparts. This discrepancy is heavily attributable to the logistical hurdles of implementing advertising in video games. In the current market there exist three methods for dispensing an advertisement to a person as he plays a video game (herein referred to as “in-game advertising”). Each technique has serious drawbacks.

The first method involves implementing a hard- coded advertising mechanism within the actual framework of the game. The implementation of this device requires that a software developer access the original source materials for the game itself. However, source materials for a video game are generally considered to be proprietary in nature and are rarely shared. Additionally, any modification to the source materials in creating the advertising mechanism then necessitates a new compilation of the video game's executable; meaning that any game already sold on the market will have to be updated by the end-user in order to enable the advertising capability. These factors impede the proliferation of in-game advertising by creating bureaucratic, technical, and marketing roadblocks between game developers, advertising companies, and consumers.

The second known method for in-game advertising can be implemented without direct access to a game's original source materials. In this scenario, software that is separate from and that does not communicate with the video game, but which is installed on the same computing device as the video game, works only to graphically render advertisements inside of the game. In contrast to the first method mentioned above, this one does not require access to the original source materials for any given software title, and it works in nearly every current and future game on the market.

This benefit is not received without a tradeoff. The software in question has no means to understand what is happening with the video game that is being played, and therefore does not know when is the proper moment to advertise to the person who is playing (referred to henceforth as the “gamer”). It must instead rely on the gamer, by way of input, to instruct the software when he would like to receive an advertisement. This circumstance shifts power away from the advertiser and into the hands of the gamer. The gamer is generally not inclined to engage frequent solicitation.

The third method for in-game advertising can be understood as identical to the second method above, but with a key exception. In this third method, the advertising software communicates and interacts with the video game that is running on the shared computing device. More specifically, the advertising software forcefully extracts information from the game's running process, and determines when there is a good opportunity to display an advertisement. The serious drawback to this method is that the intrusion of the advertising software is usually detected by the video game, at which point the flow of information is summarily halted by the video game.

In light of the foregoing, there is a need for a new technology that can advertise inside a video game without having to directly interact with its running execution process, while at the same time be able to determine, absent of user input, the best time to deliver the advertisement.

### SUMMARY OF THE INVENTION

The present invention provides systems and methods for displaying content on a computing system while an interactive game is being played over a network.

One aspect of the invention provides a method including identifying an opportunity to display content during an interactive video game and displaying content on a computing system.

An additional aspect of the invention may include analyzing the flow of network packets.

An additional aspect of the invention may include intercepting network signals.

An additional aspect of the invention may include providing substitute network signals.

An additional aspect of the invention may include analyzing the flow of graphical calls.

An additional aspect of the invention may include intercepting graphical signals.

An additional aspect of the invention may include providing substitute graphical signals.

An additional aspect of the invention may include displaying content for a period of time.

An additional aspect of the invention may include generating graphical drawing commands.

An additional aspect of the invention is a method wherein content comprises advertising.

An additional aspect of the invention is a method wherein an opportunity is a time period of low network activity.

An additional aspect of the invention may include including waiting for a program to be initialized.

An additional aspect of the invention may include determining whether the program is a supported video game.

An additional aspect of the invention may include providing a list of supported video games and comparing the executable file name of the initialized game to the list.

An additional aspect of the invention may include analyzing at least one interactive video game. The method may also include developing an algorithm to identify opportunities to display content during an interactive video game. The method may also include providing software including said algorithm to identify opportunities to display content for at least one interactive video game. The method may also include providing access to content.

An additional aspect of the invention is a method wherein the software contains an algorithm for more than one interactive video game.

An additional aspect of the invention may include analyzing the network and graphics calls of the at least one interactive video game.

### BRIEF DESCRIPTION OF THE DRAWINGS

FIG. 1 is schematic of a platform for supporting the present invention.

FIG. 2 is a schematic computer and network platform for supporting the present invention.

FIG. 3 is a flowchart showing an embodiment of a method according to the present invention.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

The present invention is a system and method for detecting moments of decreased interactivity in video game being played over a network and displaying content during that time. In the illustrated embodiment the system is software, however it is contemplated that the system could be embodied in hardware.

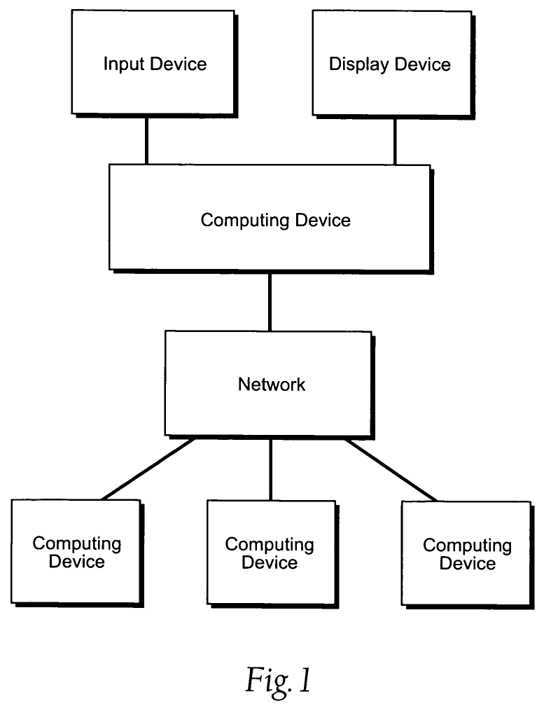

FIG. 1 shows a schematic view of a platform for supporting the software of the present invention. The software is designed to operate on a computing device connected to a network. The computing device preferably includes at least one processor, memory, a graphics processing unit (“GPU”), and a network interface controller. The network interface controller may be of any type known in the art including, but not limited to, an Ethernet card or a wireless connection. The graphics processing unit may be of any type known in the art including, but not limited to, a video card, a motherboard embedded GPU, or a processor embedded GPU. The computing device preferable also includes input means (such as a mouse, keyboard, or other game controller) and output devices (such as a display and speakers). It is contemplated that the input means and output means may be integrally formed with the computing device, or may be formed separately and be in electronic communication with the computing device. It should be understood that the computing device may be a laptop computer, desktop computer, a game console, a hand-held computing device such as a PDA or mobile communications device, or a hand-held game console.

The software is designed to be utilized with a supported interactive video game which a user or gamer plays over a network. A gamer is a person who plays an interactive video game. For example, the game may be of the type offered for multiplayer competition over the internet between gamers scattered across the world. A supported game is one in which an analysis algorithm can detect an optimal moment by analyzing the flow-rate of network packets and graphical (“rendering”) function calls related to the game.

Generally, when an interactive game, whether it is a supported game or not, is being played online, the game will frequently make requests of the network interface controller to send and receive data packets to and from the computing device. These network function calls are necessary for the gamer to send and receive updates to and from the other gamers who are simultaneously connected to the virtual game environment. Often, based upon the contents of these updates, the video game will additionally make certain graphical function calls to the graphics processing unit being used by the computing device. For example, one of the other gamers connected to the virtual game environment over the network may achieve a milestone inside of the game and send out data to inform all of the other players, either directly or by way of a shared server, that this milestone has been reached. The video game of each connected gamer, having received this information, then begins to load a new level of the video game and must therefore display a loading screen.

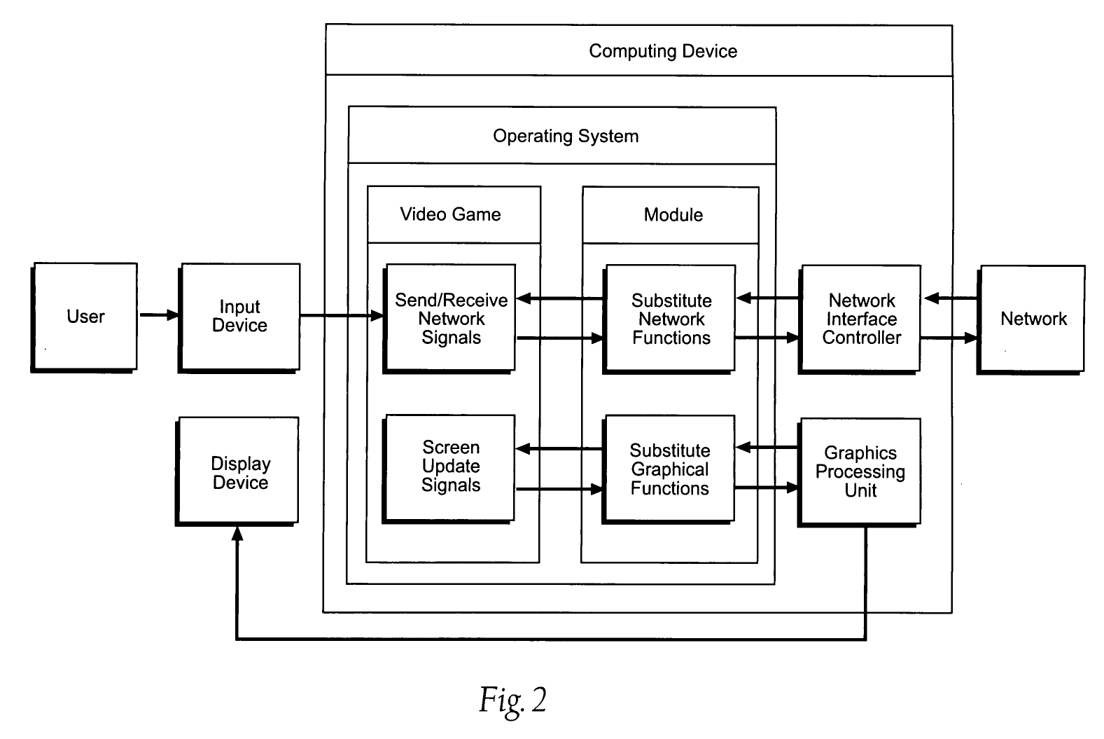

As shown in FIG. 2, the module of the present invention (whether embodiment in software or hardware) intercepts network function calls and graphical function calls and analyzes their flow-rate to determine optimum moments to display content. Knowing the current state of a game presents an opportunity to draw content on screen without disrupting the game play experience for the user. It should be understood that although the module is referred to as software below, the module may be embodied in hardware without departing from the invention.

Generally, the network flow-rate profile of interactive video games operates in one of the following states at any point in time: disconnected, connecting, reconnecting, in-game, and level change. It should be understood that the foregoing network profile states are descriptive of some of the various network profiles used by the invention to assess network activity for the sake of detecting proper content delivery periods in the game. It is not required that each network profile state occur during the operation of a supported video game. Further, it should be understood that additional network profile states may occur during the operation of a supported video game. Each game has its own unique networking model that is analyzed, but almost all follow some basic variation of these descriptive states.

In the “disconnected” state the game generates no significant network activity and is not connected to a game server. In the “connecting” state the game sends and receives packets from only one server but the flow of data has not yet stabilized. In the “reconnecting” state the game starts sending and receiving packets to or from another server. In the “in-game” state the network rates are stable and packets are sent to and received from the only one game server. In the “level change” state the network rates have destabilized but packets are still sent to and received from the same server.

Generally, the graphical data flow-rate profile of interactive video games operates in one of the following states at any given time: loading, exiting, and steady. It should be understood that the foregoing graphical profile states are descriptive of some of the various graphical profiles used by the invention to assess graphical activity for the sake of detecting proper content delivery periods in the game. It is not required that each graphical profile state occur during the operation of a supported video game. Further, it should be understood that additional graphical profile states may be occur during the operation a supported video game. Each game has its own unique graphical model that is analyzed, but almost all follow some basic variation of these descriptive states.

In the “loading” state the game asks for and receives screen updates very infrequently and sporadically, indicative of the great deal of computing power being redirected away from graphical rendering and towards the loading of game-related files into active memory. In the “exiting” state the flow-rate of screen calls drops abruptly and briefly, indicating either an exiting of the game itself or sometimes a disconnecting from the game server to a main menu interface. The “steady” state describes essentially any moment where a massive amount of computing power is not being redirected away from rendering the video game to the display. This state is the most common and encompasses those periods where the gamer is either playing the game or navigating the game's graphical menu interface.

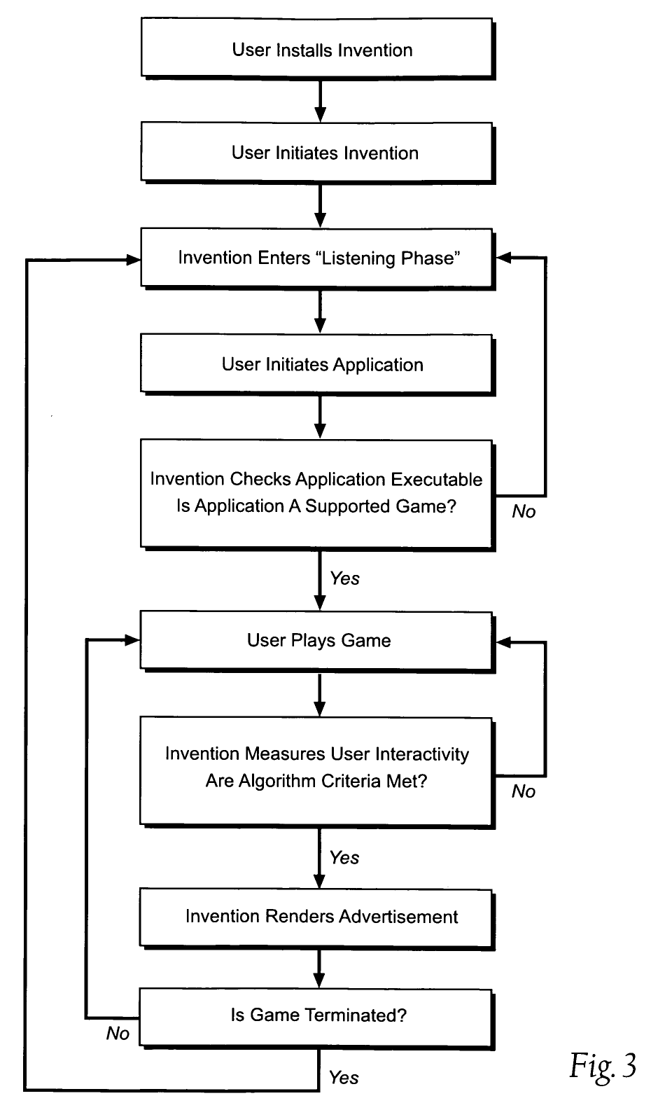

In the illustrated embodiment the system of the present invention takes the form of software. Preferably, the software of the system exhibits three modes of functionality: listening, measuring, and rendering. An embodiment of the method is shown in the flowchart of FIG. 3.

In the listening stage, a scan is conducted with each newly started application on the computing device. If the executable of a supported game is found, then a switch is made to the measuring stage.

In the measuring stage, the software of the present invention measures the flow-rate of network and graphical data as described above in order to detect any circumstance of decreased user interactivity that occurs within the video game while it is running. The software then determines “optimal moments” to display content. Depending on the game, an “optimal moment” is generally when either one or both of the network and graphical measurements determine a state that is not “in-game” and/or “steady”, respectively.

In the rendering stage, once an “optimal moment” has been detected, the system displays content to the user.

When the system enters the listening phase, it waits for a supported game to be activated on the user's computing device. During the listening phase, the system compares the executable filename of each newly initiated to the system's list of supported games. If the new application is not a supported game, the software continues in the listening phase. If the new application is a supported game, the system switches to the measuring phase and the system software is loaded into the process space of the supported game.

In the measuring phase, the system will intercept and analyze network calls and graphical function calls. The software will then determine, using an algorithm designed for the particular game and contained within the software, when an optimal moment for displaying exists.

At this point, the game begins to load into system memory. As the game initialization process continues, the computing device may be connected to a server. Upon connecting to a server, the video game will load additional game elements into system memory that were not loaded when the game was first initialized. Specifically, the game must recreate an environment in accordance with instructions from the game server, whereby this information was not readily available prior to establishing connectivity.

Upon completion of the game loading process, the user begins to play the game. The user may at any time terminate the running process of the game, at which time the invention will revert to its original “listening” state. However, until the user terminates the game process, there is the possibility of additional detectable optimal moments occurring, usually when a milestone within the game is reached and a new environment or game variable must be loaded into the system memory of the computing device.

Each time an optimal moment is detected; a content display is rendered and displayed for a period of time. The period of time may be a specifically predetermined amount of time measured in some time interval (for example a particular number of seconds) or the period of time may be determined by detecting the game setting. For example, and not by way of limitation, content may be displayed for the period of time during which nether in-game nor steady states are detected. Drawing commands may be initiated by the system and sent to the graphics processing unit to display content during an optimal moment. These drawing commands are included with the output from the computing device as a whole to the user. After the content display is removed, the user may continue playing the game. After the content draw is complete, the software returns to its measuring state.

As stated above, the measuring stage detects optimal moments to display content. The optimal moments are preferably related to the flow-rate of network packets, with the flow-rate of graphical screen update calls acting as an additional check. The software identifies only those moments of decreased user interactivity associated with supported games connected to servers, and therefore does not detect all moments of decreased user interactivity within a game, but rather only those specifically related to the flow-rate of network packets and the graphical rendering calls.

The software of the present invention conducts an analysis of both the graphical function calls initiated by the game and the flow-rate of the incoming and outgoing network packets between the computing device and its remote host. This analysis does not examine the actual contents of the network packets or graphical function calls, and is therefore non-intrusive.

Further, it should be noted that the software of the present invention detects optimal moments purely through the gathering of circumstantial evidence. In other words, the optimal moments are determined by inference rather than direct instruction. At no time does the invention directly interface itself with the video game executable, nor does it ever require input from a human observer (e.g. the gamer).

The system determines optimal moments of forced decreased user interactivity even though such information is historically known only by the video game capable of decrypting the packets and to the user experiencing the results as he attempts to play.

The software takes measurements of the flow-rate of the network and graphical traffic known to originate from the currently-detected video game. Once this data stream has been accessed, a real-time sampling is taken, whereby the sampling contains the chronological history of packet flow exiting and entering the computing device over the course of a certain period of time. As the information is collected, the invention performs a series of comparisons on the flow patterns exhibited over the stream's timeline to a predetermined model unique to the game. The results of these comparisons yield information regarding the events taking place inside of the video game. In particular, they reveal whether or not the gamer has even the opportunity to be interactive with the game, or if instead he has been forced into a state of idleness by the game for a defined period of time, such as with the previously illustrated example of the loading screen. In the event that such a forced idle state has been detected, this time period is deemed to be an optimal moment to display content to the gamer.

In the illustrated embodiment the software redirects key functions of the game, such as packet send/receive functions and a number of graphical functions. It is contemplated that the specific graphical functions redirected depends on which graphics API platform is used by the supported game. By overriding these functions the software is able to detect when the host game is sending and receiving packets and when it is updating the screen. Using this mechanism the software is able to track patterns in the game's network activity and synchronize itself with the game's screen updates. The software preferably redirects the functions by inserting substitute functions between the video game and the hardware. These functions perform the original tasks of the video game calls, and they also assess the frequency of such calls in order to determine the presence of optimal moments.

It should be noted that the function override process is invisible to the host game. When an overridden function is called by the host game, the software takes note and then calls the original function to provide the expected result. This mechanism does not degrade performance, and at no time does the software directly access any of the content from the host game.

For each supported game there is a customized algorithm that detects patterns in network and graphics activity. The detection algorithm collects statistics about the rate at which a game sends and receives network packets and requests screen updates. This information combined with a unique model generated for each game before hand enables to determine the current state of a game in real time. As stated above, by determining the current state of a game, the system can identify an opportunity to display content. The key patterns for which the software is searching for optimal moments are based on the connection and reconnection to the game server and also environment transitions, that is to say whenever the network and graphics data suggests that the current state is neither “in-game” nor “steady” respectively, as previously described.

An example of an optimal moment centers around a “loading screen”, defined herein as a transitional period in the game during which new components of the game are being loaded into the memory of the computer device on which the game's executable process is being run. An optimal moment is an opportunity to display content.

The present invention is able to detect this newly-established network communication between the game server and the game and also the corresponding rendering calls, and from that infer that a loading screen is present on the video monitor of the user. Once this inference has been made, the invention displays content inside the screen display of the game for a defined period of time. Once the period of time for ad display is over, the invention reverts back to its measuring state.

It must be noted that the method employed by the system is not limited to an initial loading process that might occur when the game is first initialized. The system does not simply rely on assumptions about user-behavior in determining moments of decreased user-interaction, such as assuming that when a game is just activated the user will be less interactive with the video game. While such an assumption might often be true, there are circumstances where this would not be the case, one example being if the user loaded the video game into memory not to play, but to customize certain variables such as input controls and display options through the video game's graphical user interface. In such a case loading time would be negligent and user interactivity would be immediate. The system employed by the present invention actively recognizes the difference and is therefore suited to recognize a true moment of decreased user interaction.

As described above, once an optimal moment has been identified, the rendering stage begins. Existing content that is either stored on the computing device or streamed from a remote server is loaded into memory by the computing device and converted into a format that can be graphically represented inside the screen display of the video game. This generally requires converting the content into readable code, including, but not limited to OpenGL™ or Direct3D™ readable code, which are the two most common graphics API for video games. The content is then displayed to the gamer.

Preferably, the content display is achieved by overlaying the provided content on top of the game rendered content while the game is in the “connecting” or “level change” network states and sometimes the “loading” graphics state. The actual drawing is done when the game calls one of the redirected graphics functions that are responsible for updating the screen, at that point additional drawing commands are issued by the system to render the content display and the screen is updated as normal. The content display preferably appears within the display screen of the game.

Additionally the custom library of the system operates a separate thread that is solely responsible for drawing content to display and updating the screen if the game itself has not done so after a set amount of time, while in the “connecting” or “level change” states. This is done because the game issues less screen update commands while in those states since most of the game's time is spent on loading resources for the next level to be played.

When an appropriate pattern is detected the software interweaves graphical drawing commands with the game's drawing commands, or when not available the system generates its own separate thread for drawing, thus enabling it to overlay content on top of the game's rendered content.

In use, the software is loaded onto the user's computing device. The software may be loaded onto the computing device by any means known in the art. The software then registers itself as a system hook, thereby gaining the ability to load itself into the process space of all newly initiated applications.

In an embodiment of the software using Windows APIs (Win32 Hooks), a dynamic library (DLL) is loaded into the application memory space of a game. Once loaded the library redirect Winsock (Windows networking library) packet sending and receiving functions to custom routines in the library itself, the library also redirects a number of OpenGL or Direct3D (depending on the graphics API used by the game) functions that are irresponsible for rendering graphics to screen.

By redirecting these core public APIs used by the game it is possible to track in real time when a game calls one of these functions. On such a call custom library code specific to the detection algorithm or content playback is executed and the original routine the game was trying to call is run, thus from the game's point of view there is no disruption in the execution flow nor are there any side effects caused by the custom library.

As seen in FIG. 2, in operation, input commands generated by the user as a result of playing the game are relayed to the video game. Gamestate updates are sent from the video game through the process space of the software and across the network to other gamers who are connected to the network. These updates are generally created, either directly or indirectly, as a result of user input. As these updates pass through the process space of the system, the flow-rate and related details are recorded.

Additional gamestate updates are sent from the server through the network to the video game being played by the user. These updates pass through the process space of the invention. As these updates pass through the process space of the system, the flow-rate and related details are recorded.

Graphical function calls are sent from the video game to the graphics processing unit through the process space of the system. These graphical function calls are generated, either directly or indirectly, in response to input commands from the user and network gamestate updates. Graphical function calls include, but are not limited to screen update calls.

It is contemplated that the content displayed during optimal moments may comprise advertisements. It should be understood that the content displayed during optimal moments may be provided by any person or business. The content may be provided by the developer of a supported game or by a party unrelated to the game development. It is contemplated that the content may take any form known in the art, for example video, audio, still images, and any combination thereof. The content can either be bundled with the software of the present invention during an initial download or installation, or it can be downloaded from a server after the software has been installed. The particular form and delivery method of the content may be determined based on the desires of the party providing the content.

It is contemplated that the user may initiate the invention by installing the invention onto a computing device, either directly or as an element bundled with other software provided by separate developers. The software may be installed by any means known in the art. It is contemplated that the system of the present invention may automatically be initiated each time the user turns on their computing device, or the system may be manually initiated by the user either directly or by way of activating other software that the invention has been integrated into.

It is contemplated that the system of the present invention could be utilized with any type of game played on a network, such as the internet. The game may be a single player game or a multi-player game.

It is further contemplated that the software would be provided with a particular game and with an algorithm to run for that particular game. In such an instance the software would not need to include the step of determining whether the game is supported. Rather, when the game is started, the software could proceed directly to a step of determining an optimal moment to display content.

It should be understood that the algorithm in the software of the present invention is based on an analysis completed on the game. Each game is analyzed and an algorithm for that particular game is developed. Therefore, the software will have a list of games which have been analyzed and are supported by the software, in other words the software includes the algorithm for that particular game. It is contemplated that the software could be updated to include additional supported games. It is contemplated that the software update could occur using any means known in the art, including, but not limited to being downloaded by the user or being automatically downloaded without the user's direction.

Although the system of the present invention is described above as being embodied in software, it is should be noted that the invention does not have to operate within the confines of the operating system as software. It is contemplated that the system could be implemented as hardware configured to operate between the operating system and the hardware that is responsible for network and graphics functions, such as the NIC card and the video card respectively.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I/We claim:

1. A method of displaying content on a computing system while an interactive video game is being played over a network, the method comprising:
identifying an opportunity during an interactive video game to display content; and
displaying content on the computing system.

2. The method of claim 1 wherein said identifying step further comprises analyzing the flow of network packets.

3. The method of claim 2 further comprising intercepting network signals.

4. The method of claim 3 further comprising providing substitute network signals.

5. The method of claim 1 wherein said identifying step further comprises analyzing the flow of graphical calls.

6. The method of claim 5 further comprising intercepting graphical signals.

7. The method of claim 6 further comprising providing substitute graphical signals.

8. The method of claim 1 wherein the displaying step further comprises displaying content for a period of time.

9. The method of claim 1 wherein the displaying step further comprises generating graphical drawing commands.

10. The method of claim 1 wherein said content comprises advertising.

11. The method of claim 1 wherein said opportunity further comprises a time period of low network activity.

12. The method of claim 1 further comprising waiting for a program to be initialized;

13. The method of claim 12 further comprising determining whether the program is a supported video game;

14. The method of claim 13 wherein said determining step further comprises providing a list of supported video games and comparing the executable file name of the initialized game to said list.

15. A method of providing content during an interactive video game comprising:
analyzing at least one interactive video game;
developing an algorithm to identify opportunities to display content during said interactive video game;
providing software, said software including said algorithm to identify opportunities to display content for at least one interactive video game; and
providing access to content.

16. The method of claim 15 wherein the software contains an algorithm for more than one interactive video game.

17. The method of claim 15 wherein said analyzing step further comprises analyzing the network and graphics calls of the at least one interactive video game.
